(19) United States
(12) Patent Application Publication
(10) Pub. No.: US 2025/0217727 A1
(43) Pub. Date: Jul. 3, 2025

(54) METHOD AND AN APPARATUS FOR PROCESSING ROLE INFORMATION IN A PROJECT MANAGEMENT SYSTEM, AND A STORAGE MEDIUM

(71) Applicant: Beijing Zitiao Network Technology Co., Ltd., Beijing (CN)

(72) Inventors: Chunshuo YANG, Beijing (CN); Dechuan PAN, Beijing (CN); Long FENG, Beijing (CN)

(21) Appl. No.: 19/003,943

(22) Filed: Dec. 27, 2024

(30) Foreign Application Priority Data
Dec. 28, 2023 (CN) 202311843643.8

(51) Int. Cl. G06Q 10/0631; G06Q 10/10

(52) U.S. Cl. CPC G06Q 10/06311; G06Q 10/103

(57) ABSTRACT

Embodiments of the present disclosure disclose a method and apparatus for processing role information in a project management system, and an electronic device. A specific implementation of the method includes: determining, in a project management system, a role person of a first process node from role persons bound by a parent node of the first process node, based on a role person synchronization rule of the first process node in a first project, wherein the role person synchronization rule indicates a rule for the first process node to inherit the role person from the parent node of the first process node; and displaying the role person of the first process node in a project management interface of the project management system.

### CROSS-REFERENCE TO RELATED APPLICATION

This application claims the priority to and benefits of the Chinese Patent Application, No. 202311843643.8, which was filed on Dec. 28, 2023. The aforementioned patent application is hereby incorporated by reference in its entirety.

### TECHNICAL FIELD

The present disclosure relates to the field of computer technologies, and in particular, to a method and apparatus for processing role information in a project management system, and an electronic device.

### BACKGROUND

With the development of computers, users can implement various functions using electronic devices. For example, a user can interact with another user through an electronic device, or can use the electronic device to promote work.

In some scenarios, a data management-based tool or platform (for example, a project management system) may be built. By creating a standardized business process, the project launch can be accelerated and the project risks can be avoided.

### SUMMARY

This section is provided to introduce concepts in a simplified mode, which will be described in detail in the section of Detailed Description of Embodiments. This section is neither intended to identify key or necessary features of the claimed technical solutions, nor is it intended to be used to limit the scope of the claimed technical solutions.

In a first aspect, an embodiment of the present disclosure provides a method for processing role information in a project management system. The method includes: determining, in a project management system, a role person of a first process node from role persons bound to a parent node of the first process node, based on a role person synchronization rule of the first process node in a first project, wherein the role person synchronization rule is used to indicate a rule that the first process node inherits the role person from the parent node of the first process node; and displaying the role person of the first process node in a project management interface of the project management system.

In a second aspect, an embodiment of the present disclosure provides an apparatus for processing role information in a project management system. The apparatus includes: a determination unit, configured to determine, in a project management system, a role person of a first process node from role persons bound to a parent node of the first process node, based on a role person synchronization rule of the first process node in a first project, wherein the role person synchronization rule is used to indicate a rule that the first process node inherits the role person from the parent node of the first process node; and a display unit, configured to display the role person of the first process node in a project management interface of the project management system.

In a third aspect, an embodiment of the present disclosure provides an electronic device. The electronic device includes: one or more processors; and a storage apparatus, configured to store one or more programs, where the one or more programs, when executed by the one or more processors, cause the one or more processors to implement the method for processing role information in a project management system according to the first aspect.

In a fourth aspect, an embodiment of the present disclosure provides a computer-readable medium having a computer program stored thereon, where the program, when executed by a processor, implements the steps of the method for processing role information in a project management system according to the first aspect.

It should be noted that the method for processing role information in the project management system provided in this embodiment may determine, in the project management system, the role person of the first process node from role persons bound to the parent node of the first process node, based on the role person synchronization rule of the first process node in the first project, wherein the role person synchronization rule is used to indicate the rule that the first process node inherits the role person from the parent node of the first process node. Therefore, for a child process node in a project, the role person in the parent node of the child process node may be inherited to automatically determine the role person in the child process node. When the project is hierarchically disassembled or the role person is updated, it is avoided to fill in the role person manually one by one, thereby reducing the labor cost and improving the speed and accuracy of determining the role person in the child process node.

### BRIEF DESCRIPTION OF DRAWINGS

The above and other features, advantages, and aspects of the embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a flowchart of an embodiment of a method for processing role information in a project management system according to the present disclosure;

FIG. 2A, FIG. 2B, FIG. 2C, and FIG. 2D are schematic diagrams of an application scenario of the method for processing role information in the project management system according to the present disclosure;

FIG. 3 is a schematic diagram of an application scenario of the method for processing role information in the project management system according to the present disclosure;

FIG. 4 is a schematic diagram of an application scenario of the method for processing role information in the project management system according to the present disclosure;

FIG. 5 is a schematic structural diagram of an embodiment of an apparatus for processing role information in a project management system according to the present disclosure;

FIG. 6 is a schematic diagram of an example system architecture in which the method for processing role information in the project management system according to an embodiment of the present disclosure can be applied; and

FIG. 7 is a schematic diagram of a basic structure of an electronic device according to an embodiment of the present disclosure.

### DETAILED DESCRIPTION

Embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. In addition, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

Here, for the convenience of description, some concepts that may be involved in the present disclosure are first described.

A space (Space) is a basic unit of organization collaboration, which may be management of a single project or a collection of a plurality of projects.

A work item (Work Item) is a collaborative work item, or may be a collection of work items disassembled by a project. Work items may be divided into different types according to different content, for example, a feature, an issue, a version, an iteration, and a milestone.

A feature (Feature) may refer to a software function required by a user to solve a specific problem/achieve a specific goal, which may help team members to track specific details.

An issue (Issue) refers to a business requirement that does not conform to an initially defined business requirement. For example, a pop-up window does not display, etc.

A view (View) is a collection of work item query dimensions frequently concerned in a team, which is solidified. The view may also be referred to as a view special item. The view may have various types, for example, a table, a list, a kanban, a Gantt chart, and metrics. The table may be an arrangement combination of field information in which data is arranged in a cell mode. The Gantt chart may display the progress of the project in a time dimension through a bar chart. The metrics is a continuous quantitative process of data definition, collection, and analysis of a software development project, a process, and its products. For example, requirements throughput, quality, cycle, and manpower estimation and assessment.

Source data is data of a whole work item for targeted measurement. For example, the source data may include a work item, such as a feature, an issue, a version, and an iteration. The source data may include view data, such as an in-progress feature pool, an issue to be processed by me, and a user-defined view name. The source data may include a single instance, for example, a specific data range is a specific feature, issue, version, iteration, or the like.

A role (Role); various roles are involved in the project, and a project needs the cooperation and support of different roles.

A process is a basic step in a life cycle of an item, and is composed of process nodes and execution manners in an orderly manner. A node may refer to a stage segmentation point of a process.

A root work item is a work item at an uppermost layer, and may generally be named as a project. The root work item may be associated with a general process of the project.

A child process node, which may also be referred to as a child node, is a node associated with a work item (that is, a child work item) that is disassembled in a process of a work item (a root work item or a parent work item of a non-root work item). Another child process node may be further disassembled in a process under the work item corresponding to this node, to implement process nesting. Alternatively, the work item corresponding to this node may not be further disassembled.

A child process work item is a work item associated with a child process node.

A task is a smallest unit of item (a special work item) that cannot be further disassembled.

A WBS (Work Breakdown Structure) schedule is a powerful tool for promoting a large project, and can effectively identify dependencies and risks. A WBS is created to disassemble a project into various work packages based on deliverables in phases. Generally, the project is disassembled in the sequence of project→phase→domain→feature→task. In some WBS products, instances can be disassembled hierarchically to implement a hierarchical structure of the WBS schedule. Different arrow orders correspond to different sub-processes and node hierarchies in the WBS schedule. Because the project is disassembled from top to bottom into a plurality of hierarchical instances to a granularity process of a minimum execution task, there is a feature for role person transfer between the disassembled instances with hierarchical attributes. Division of labor and collaboration from role person appointment to execution are implemented.

A schedule root work item is a work item at an uppermost layer of a WBS schedule, and is generally named as a project.

A child process node is a node associated with an instance that is disassembled in a process of the schedule root work item of a WBS schedule. Another child process node may be further disassembled in a process under the instance corresponding to this node, to implement process nesting.

A child process instance is an instance associated with a child process node of a WBS schedule.

A deliverable is deliverable content set on a node or a task in a WBS schedule, and controls a completion condition of the node or the task. The node or the task in the schedule reaches a completion criterion only after a specified deliverable instance is completed.

One or more embodiments provided in the present disclosure support disassembling instances with a hierarchical relationship in a process nesting mode to transfer a role person, to implement transfer of a parent role person to a child role person.

One or more embodiments provided in the present disclosure support disassembling instances with a hierarchical relationship in a process nesting mode to perform linked deletion, to implement deletion of a parent and deletion of a child at the same time.

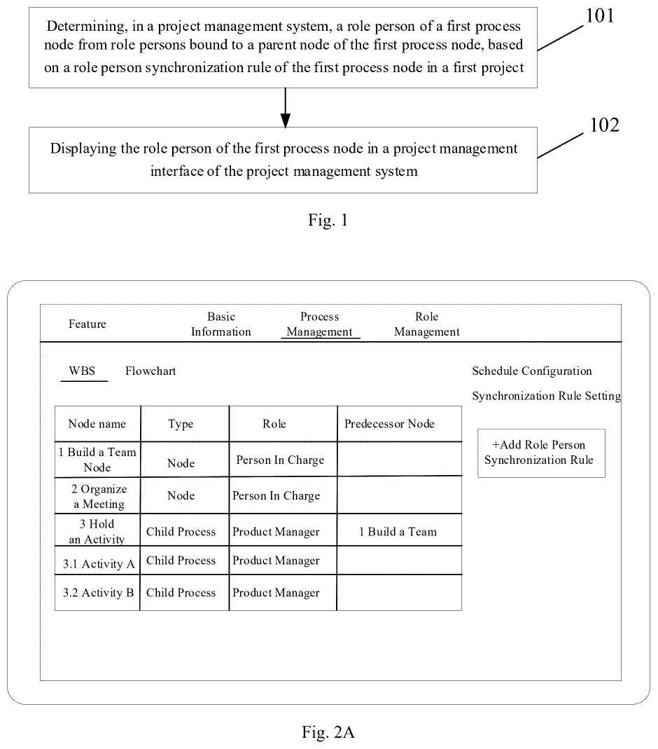

Reference is made to FIG. 1, which shows a process of an embodiment of a method for processing role information in a project management system according to the present disclosure. As shown in FIG. 1, the method for processing role information in the project management system includes the following steps.
Step 101: determining, in a project management system, a role person of a first process node from role persons bound to a parent node of the first process node, based on a role person synchronization rule of the first process node in a first project, wherein the role person synchronization rule is used to indicate a rule that the first process node inherits the role person from the parent node of the first process node.

In this embodiment, an execution subject (for example, a server and/or a terminal device) of the method for processing role information in the project management system may determine, in the project management system, the role person of the first process node from the role persons bound to the parent node of the first process node based on the role person synchronization rule of the first process node in the first project.

Here, the role person synchronization rule is used to indicate a rule that the first process node inherits the role person from the parent node of the first process node.

Here, the foregoing role person synchronization rule may be pre-configured. The foregoing role person synchronization rule is correspondingly set for the first process node. In other words, different process nodes in the first project may be configured with different role person synchronization rules.

Here, role persons of the parent node may be role persons bound to the parent node.

For example, the role person of the first process node may be determined from persons with various roles in the parent node. For example, a technician in the parent node is determined as a person in charge of the first process node.

The first process node may be any child process node in the first project.
Step 102: displaying the role person of the first process node in a project management interface of the project management system.

Here, the project management interface may be an interface for managing a project, for example, a WBS schedule, a flowchart, an instance details page, or an instance view.

Optionally, the role person of the first process node may be displayed when the role person of the first process node satisfies a display condition.

It should be noted that the method for processing role information in the project management system provided in this embodiment may determine, in the project management system, the role person of the first process node from role persons bound to the parent node of the first process node, based on the role person synchronization rule of the first process node in the first project, wherein the role person synchronization rule is used to indicate the rule that the first process node inherits the role person from the parent node of the first process node in the project management system, the role person of the first process node in the first project based on the role person synchronization rule of the first process node, from the role persons bound to the parent node of the first process node, where the role person synchronization rule is used to indicate the rule for the first process node to inherit the role person from the parent node of the first process node. Therefore, for a child process node in a project, the role person in the parent node of the child process node may be inherited to automatically determine the role person in the child process node. When the project is hierarchically disassembled or the role person is updated, it is avoided to fill in the role person manually one by one, thereby reducing the labor cost and improving the speed and accuracy of determining the role person in the child process node.

In contrast, in some related technologies, during project management, it cannot meet the requirement for automatically synchronizing different roles by role persons at different hierarchical levels when a user hierarchical levels is disassembled. Instead, the role persons are filled in manually one by one, resulting in high labor costs and inconvenience for large projects.

In some embodiments, the parent node is a superior node in a node link where the first process node is located. The node link may include a link formed by a root work item to the first process node.

In this way, role persons of a direct parent node and an indirect parent node of the first process node may be synchronized to the first process node, to implement a flexible role person integration manner, thereby improving the convenience of integrating role persons from a superior node.

In some embodiments, displaying the role person of the first process node in the project management interface of the project management includes: initializing the role person in the first process node in response to creating the role person synchronization rule, and displaying the initialized role person in the first process node; modifying the role person in the first process node in response to the role person in the parent node being modified, and displaying the modified role person in the first process node; and displaying the role person of the first process node in response to a role of the first process node satisfying a preset visibility condition.

For example, the role person of the first process node may be displayed in the project management interface such as the WBS schedule, the flowchart, the instance details page, or the instance view.

When the foregoing project management interface is displayed, if the following opportunities occur: when the role person synchronization rule is created, the role person in the parent node is modified, and the role of the first process node satisfies the preset visibility condition, the role person of the first process node is displayed.

In this way, the display of the role person of the first process node can be quickly implemented when the display opportunity is satisfied, thereby improving the display timeliness and accuracy.

In some embodiments, the method further includes: displaying a first schedule configuration interface of the first project, wherein the first schedule is used to display a work breakdown structure of the first project; and configuring the role person synchronization rule of the first process node based on a configuration operation for the first process node displayed in the first schedule configuration interface.

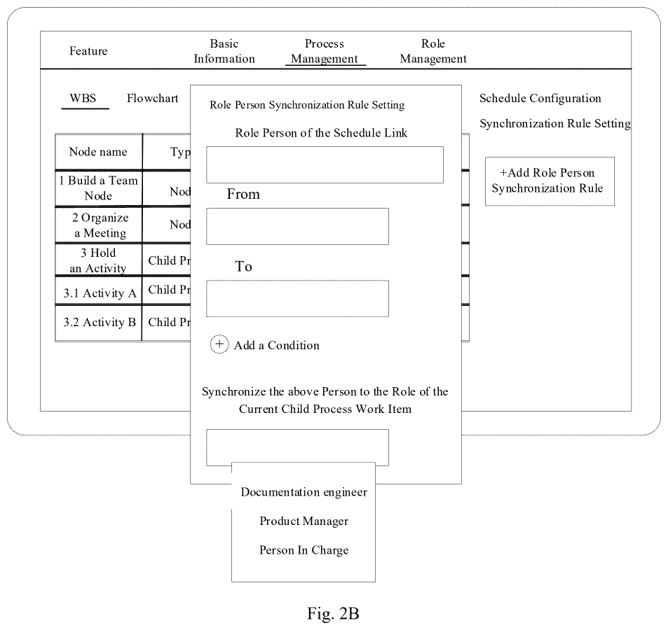

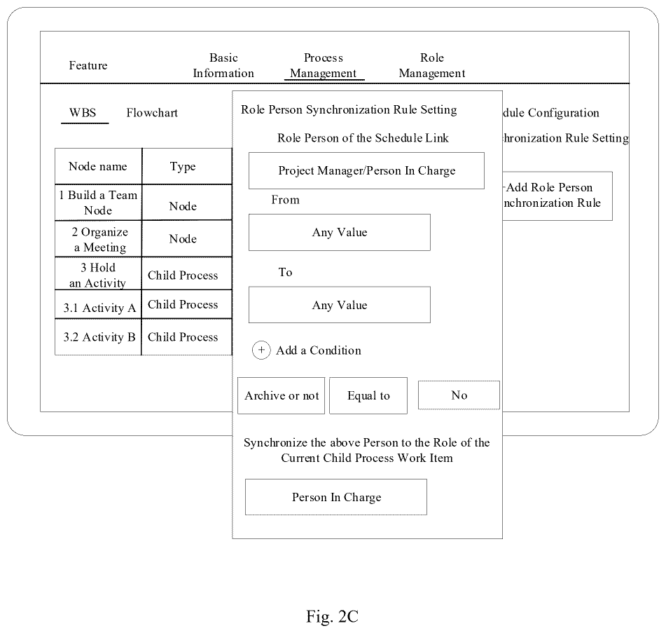

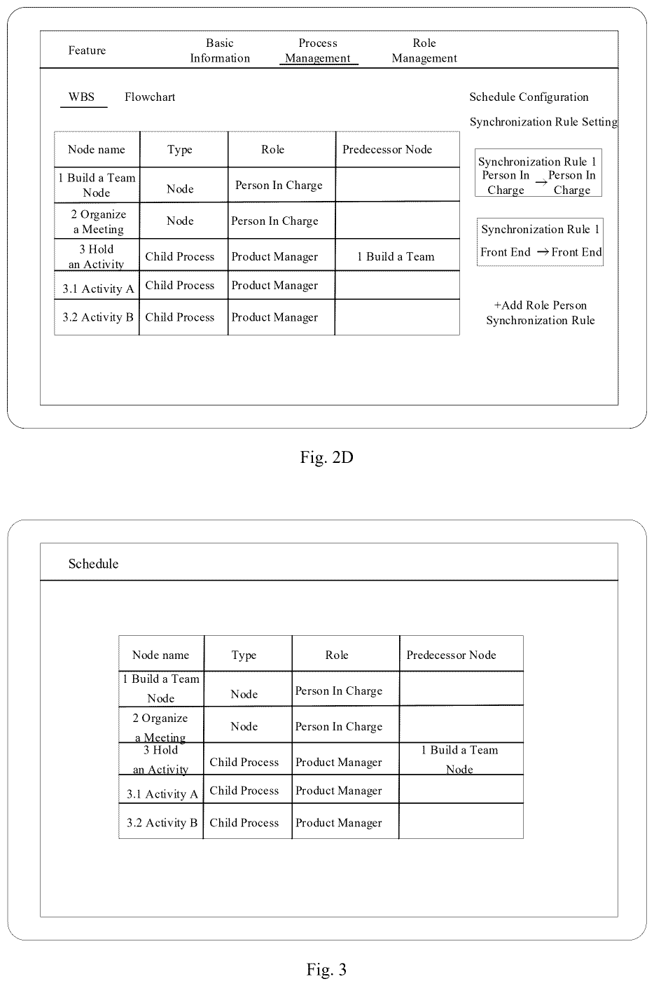

For example, as shown in FIG. 2A, FIG. 2A shows a schedule configuration interface.

In some embodiments, a new setting item is added to a schedule (WBS) configuration module in schedule process configuration. The setting item may be used to add a child process role person synchronization rule.

The setting item may be triggered to display a configuration interface. For example, a role person synchronization rule addition control in FIG. 2A is triggered to display the interface shown in FIG. 2B. Content is entered in the interface shown in FIG. 2B to display the interface shown in FIG. 2C. After the configuration operation, the interface shown in FIG. 2D may be displayed.

In the configuration interface, a role identifier of a first party (a parent node) of a schedule link may be configured. The role identifier of the first party may be the role of the schedule link. The role identifier of the second party may be the role of the child process work item. The schedule link may select a root work item and another work item in the schedule link where a current child process work item is located. After a work item is triggered and expanded, a role of a work item to which the child process belongs may be selected.

In the configuration interface, a change condition of the role identifier of the first party may be configured. For example, as shown in FIG. 2C, a project manager/project leader can be modified from any value to any value.

In this way, the role person synchronization rule of the node can be centrally configured in the schedule configuration interface, to quickly complete the role person setting of the project and improve the project promotion speed. Because the role person is automatically inherited, errors in the project person setting can be avoided and the accuracy of the role person can be improved.

In some embodiments, the role person synchronization rule includes a synchronization condition, wherein the synchronization condition is used to indicate a condition satisfied by the first process node when the first process node inherits the role person.

The synchronization condition may be configured in the configuration interface. After the synchronization condition is expanded, a field condition of a child process work item that is being configured on the schedule may be selected. The sub-conditions support: AND, OR, and formula.

Optionally, for some exceptional cases, for example, a selected child process is deleted, a selected role is deleted, a role of the first party (a parent node) is deleted, or a role of the second party (a child node) is deleted, a reminder may be sent. Specifically, after entering a specific rule configuration, there is a more specific exceptional reminder on deletion.

Optionally, when a child process is deleted, the role person synchronization rule is deleted at the same time. Although the type of the child process work item is disabled, the corresponding rule can be edited normally because is the existence of stock data.

In this way, the inheritance of the role person may be performed when the first process node satisfies a preset synchronization condition, to implement a more accurate synchronization opportunity.

In some embodiments, the synchronization condition includes: stopping synchronization when the first process node is completed.

In some embodiments, a synchronization condition is added as: an archive status is equal to NO. When there is a change in a role person in a project, for a task that has been completed historically, it may not be expected to change the person in charge. In this way, the role person is no longer synchronized to the completed child process, thereby improving the accuracy of project management.

In some embodiments, the synchronization rule includes a first role in the first process node and a role in the parent node that corresponds to the first role.

In some embodiments, determining the role person of the first process node from the role persons of the parent node of the first process node, and displaying the role person of the first process node include: determining a role person in the first role in the first process node based on the role person in the role in the parent node that corresponds to the first role.

For example, all role persons in a child node are synchronized from and overwritten with role persons in a parent node.

In this way, overall synchronization of role persons may be implemented based on roles on a parent-child hierarchical instance in the WBS schedule.

In some embodiments provided in the present application, the parent-child instance in the schedule is a disassembly of an entire project delivery process. A child instance cannot exist independently from a parent instance, and there is a clear linkage in a delete or trim operation.

In some embodiments, the method further includes: deleting, for a second process node in a second project in the project management system, a work item bound to the second process node and a work item bound to a child process node of the second process node in response to deleting the second process node; terminating, for the second process node in the second project in the project management system, the work item bound to the second process node and the work item bound to the child process node of the second process node in response to terminating the second process node; and restoring the work item bound to the second process node and the work item bound to the child process node of the second process node in response to restoring the deleted second process node or the terminated second process node

For example, as shown in FIG. 3, FIG. 3 shows a schematic diagram of a schedule. In FIG. 3, a delete operation, a terminate operation, a restore operation, and the like may be performed.

For example, when the child process node “hold an event” is deleted, the two child processes “event A” and “event B” may be linked and deleted.

In some embodiments, deleting, for the second process node in the second project in the project management system, a work item bound to the second process node and a work item bound to a child process node of the second process node in response to deleting the second process node includes: displaying a second schedule of the second project in the project management interface of the project management system, wherein the second schedule is used to display a work breakdown structure of the second project; deleting the work item bound to the second process node and the work item bound to the child process node of the second process node in response to detecting a delete operation for the second process node in the second schedule; and terminating the work item bound to the second process node and the work item bound to the child process node of the second process node in response to detecting a terminate operation for the second process node in the second schedule.

In some embodiments, the method further includes: displaying a details page of a root work item corresponding to a root node of a second project; and deleting a child work item of the root work item in response to a delete operation for the root work item of the second project.

In some embodiments, when the root work item is deleted, the number of instances that need to be deleted together needs to be calculated. The root instance of the schedule may be deleted at the instance level. When deleting, a reminder will pop up, and all child instances under the current instance will be linked and deleted. The number of all instances linked to the schedule under the current work item is calculated, and the text of the names of the first two work items is displayed in the prompt text. If there is only one work item, only the text of one work item is displayed. Optionally, the pop-up window interaction uses a delayed confirmation interaction pop-up window. A delete confirmation text checkbox can be clicked only after a preset duration countdown. The OK button of the pop-up window can be clicked only after the delete confirmation text checkbox is clicked.

In some embodiments, for a single instance deletion scenario, it is necessary to prohibit the instance deletion initiated separately from the instance side, and the current instance can only be deleted through linkage of the child process node.

In some embodiments, the method further includes: displaying a details page of a target work item bound to a fourth process node, wherein the fourth process node is not a project root node, and the target work item establishes a binding relationship with the fourth process node in a second schedule; and displaying third prompt information in response to a delete operation for the target work item in the details page of the target work item, wherein the third prompt information is used to prompt that deleting a work item bound to a child process node in the second schedule is not supported in the details page; and displaying fourth prompt information in response to a terminate operation for the target work item in the details page of the target work item, wherein the fourth prompt information is used to prompt that terminating a work item bound to a child process node in the second schedule is not supported in the details page.

In some embodiments, for a batch instances deletion scenario, batch deletion needs to check the number of instances generated at a schedule hierarchy in the currently deleted instances, and give an error prompt to the user side. After the operation deletion fails, a normal fixed view is generated to display a specific instance.

In some embodiments, the method further includes: displaying a flowchart of a second project in the project management interface of the project management system; and displaying first reminder information and a first reason input control in response to a delete operation for a third process node in the flowchart.

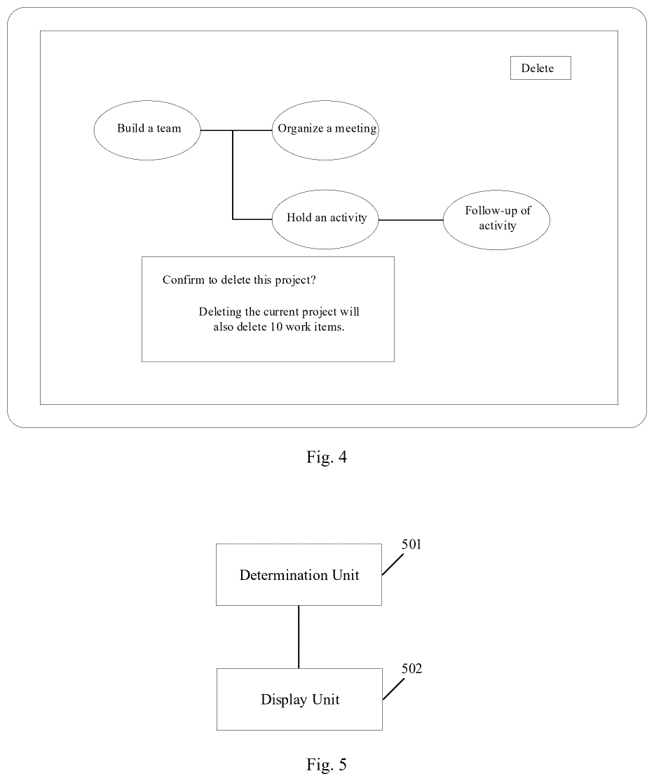

For example, refer to FIG. 4. FIG. 4 shows a flowchart of a work item, and operations such as deletion, termination, and restoration may be performed in the flowchart.

In some embodiments, for a single child process node deletion scenario, after the child process node is deleted, the number of instances that need to be deleted together needs to be calculated, including an instance associated with the current child process node and an instance associated with another child process node under the current child process node. When the schedule is published, the following operations need to be performed at the same time while the selected child process node is deleted: deleting the instance associated with the current child process node; and deleting the instance associated with all child process nodes under the current child process. For example, in the operation record, an operation record of adding a child process instance is added. Deletion: a schedule child process node is deleted at 2023-04-23 11:23:09, and this instance is automatically deleted. Restoration: a schedule child process node is restored at 2023-04-23 11:23:09, and this instance is automatically restored.

In some embodiments, for a batch child process nodes deletion scenario, when child process nodes are deleted in batch, the number of all child process node instances under the currently selected child process nodes needs to be calculated to prompt to delete the child process nodes in batch and delete the associated instances at the same time.

Optionally, if the child process node is invisible, the child process instance is deleted at the same time. When the child process node becomes visible, the instance is restored to a normal state, and all data is retained.

Optionally, when a child process node is trimmed, if there is only one node under the child process node, an error prompt box needs to pop up on a front-end page to remind: at least one node needs to exist under the child process node.

In some embodiments, for a deliverable-related scenario, when a schedule node is trimmed (including: manual deletion, visibility control, process upgrade, etc.), for a normal node: the deliverable under the node will be deleted at the same time. For a child process node: the deliverable of the node in the child process instance will be deleted at the same time. When a schedule node is restored (including: flowchart restoration, and visibility restoration), the deliverable related to the node is restored at the same time.

In some embodiments, for a child process node restoration scenario, after the child process node is restored, all other child processes and associated instances under the child process need to be restored at the same time. All information such as the person in charge of the child process node, the schedule, and the node flow is retained. All field values and node values on the child process instance are retained as the values before deletion.

In some embodiments, terminating, for the second process node in the second project in the project management system, the work item bound to the second process node and the work item bound to the child process node of the second process node in response to terminating the second process node includes: terminating the work item bound to the second process node and the work item bound to the child process node of the second process node in response to detecting a terminate operation for the second process node in the second schedule.

In some embodiments, the method further includes: displaying second prompt information and a first reason input control in response to a terminate operation for a root work item of a second project.

In some embodiments, for a single schedule root instance termination scenario, only the root work item in the schedule can be terminated. Other child process instances cannot be terminated at the instance level. When an instance is terminated, all child process instances under the current work item need to be terminated. When the instance is terminated, the number of instances that need to be linked and terminated needs to be calculated.

For example, only an instance that is not a child process can click a terminate button at the instance level. That is, in this feature, only the root work item of the schedule can be terminated. When the instance is terminated, a text prompt is required, and any two work item names of the child instance are spliced into a text as the prompt. Herein, if there is only one work item in the child instance, only one name is displayed. A terminate reason uses a general reason drop-down option box. The child process instance cannot be terminated, and the terminate operation needs to be disabled on the interface. After the mouse hovers on the disabled terminate operation, a text is displayed: the current instance is associated with the child process node, and separate termination is not supported. After the child process instance is terminated together with the root work item, the restore button here is also disabled. After the mouse hovers on the disabled restore button, a text is displayed: the current instance is associated with the child process node, and separate restoration is not supported.

In some embodiments, restoring the work item bound to the second process node and the work item bound to the child process node of the second process node in response to restoring the deleted second process node or the terminated second process node includes: restoring the work item bound to the second process node and the work item bound to the child process node of the second process node in response to a restore operation for the second process node in the second schedule.

In some embodiments, the method further includes: displaying a restore control when the schedule includes an unpublished deleted node.

In some embodiments, only the root work item in the schedule can be restored. Other child process instances cannot be restored at the instance level.

For example, to restore an instance, all child process instances under the current work item need to be restored. Only an instance that is not a child process can click a restore button at the instance level. That is, in this feature, only the root work item of the schedule can be restored. When the instance is restored, a text prompt is required, and any two work item names of the child instance are spliced into a text as the prompt. Here, if there is only one work item in the child instance, only one name is displayed. A restore reason uses a general reason drop-down option box.

In some embodiments, an instance generated through a child process node does not support separate termination on a details page.

In some embodiments, after a node is deleted, a V2 deliverable under the node also needs to be deleted. After the node is restored, the deliverable is restored at the same time.

If a deliverable of a preset level is associated under the node and the deliverable is manually deleted, the deliverable manually deleted by the user is not restored when the node is restored after deletion. That is, after a child task becomes not visible, the deliverable is linked and deleted. After the child task becomes visible, the deliverable is re-created. After the child task is manually deleted, the deliverable is linked and deleted.

With further reference to FIG. 5, as an implementation of the method shown in the foregoing drawings, the present disclosure provides an embodiment of an apparatus for processing role information in a project management system. This apparatus embodiment corresponds to the method embodiment shown in FIG. 1. This apparatus may be specifically applied to various electronic devices.

As shown in FIG. 5, the apparatus for processing role information in the project management system in this embodiment includes: a determination unit 501 and a display unit 502. The determination unit is configured to determine, in a project management system, a role person of a first process from role persons bound to a parent node of the first process node, based on a role person synchronization rule of the first process node in a first project, wherein the role person synchronization rule is used to indicate a rule that the first process node inherits the role person from the parent node of the first process node. The display unit is configured to display the role person of the first process node in a project management interface of the project management system.

In this embodiment, for specific processing of the determination unit 501 and the display unit 502 in the apparatus for processing role information in the project management system and the technical effects brought thereby, reference may be made to the related descriptions of Step 101 and Step 102 in the corresponding embodiment shown in FIG. 1, which will not be repeated here.

In some embodiments, determining the role person of the first process node from the role persons of the parent node of the first process node, and displaying the role person of the first process node include: determining and displaying the role person of the first process node from the role persons bound to the parent node based on a role person synchronization rule, wherein the role person synchronization rule is used to indicate a rule for the first process node to inherit the role person from the parent node of the first process node.

In some embodiments, the role person synchronization rule includes a synchronization condition, wherein the synchronization condition is used to indicate a condition satisfied by the first process node when the first process node inherits the role person.

In some embodiments, the synchronization condition includes: stopping synchronization when the first process node is completed.

In some embodiments, the synchronization rule includes a first role in the first process node and a role in the parent node that corresponds to the first role. The determining the role person of the first process node from the role persons of the parent node of the first process node, and displaying the role person of the first process node include: determining a role person in the first role in the first process node based on the role person in the role in the parent node that corresponds to the first role.

In some embodiments, the display unit is further configured to: initialize the role person in the first process node in response to creating the role person synchronization rule, and display the initialized role person in the first process node; modify the role person in the first process node in response to the role person in the parent node being modified, and display the modified role person in the first process node; and display the role person of the first process node in response to a role of the first process node satisfying a preset visibility condition.

In some embodiments, the parent node is a superior node in a node link where the first process node is located.

In some embodiments, the apparatus is further configured to: delete, for a second process node in a second project in the project management system, a work item bound to the second process node and a work item bound to a child process node of the second process node in response to deleting the second process node; terminate, for the second process node in the second project in the project management system, the work item bound to the second process node and the work item bound to the child process node of the second process node in response to terminating the second process node; and restore the work item bound to the second process node and the work item bound to the child process node of the second process node in response to restoring the deleted second process node or the terminated second process node.

In some embodiments, deleting, for the second process node in the second project in the project management system, a work item bound to the second process node and a work item bound to a child process node of the second process node in response to deleting the second process node includes: displaying a second schedule of the second project in the project management interface of the project management system, wherein the second schedule is used to display a work breakdown structure of the second project; deleting the work item bound to the second process node and the work item bound to the child process node of the second process node in response to detecting a delete operation for the second process node in the second schedule; and terminating the work item bound to the second process node and the work item bound to the child process node of the second process node in response to detecting a terminate operation for the second process node in the second schedule.

In some embodiments, terminating, for the second process node in the second project in the project management system, the work item bound to the second process node and the work item bound to the child process node of the second process node in response to terminating the second process node includes: terminating the work item bound to the second process node and the work item bound to the child process node of the second process node in response to detecting a terminate operation for the second process node in the second schedule.

In some embodiments, restoring the work item bound to the second process node and the work item bound to the child process node of the second process node in response to restoring the deleted second process node or the terminated second process node includes: restoring the work item bound to the second process node and the work item bound to the child process node of the second process node in response to a restore operation for the second process node in the second schedule.

In some embodiments, the apparatus is further configured to: display a restore control when the schedule includes an unpublished deleted node.

In some embodiments, the apparatus is further configured to: display a flowchart of a second project in the project management interface of the project management system; and display first reminder information and a first reason input control in response to a delete operation for a third process node in the flowchart.

In some embodiments, the apparatus is further configured to: display a details page of a root work item corresponding to a root node of a second project; and delete a child work item of the root work item in response to a delete operation for the root work item of the second project.

In some embodiments, the apparatus is further configured to: display second prompt information and a first reason input control in response to a terminate operation for a root work item of a second project.

In some embodiments, the apparatus is further configured to: display a details page of a target work item bound to a fourth process node, wherein the fourth process node is not a project root node, and the target work item establishes a binding relationship with the fourth process node in a second schedule; and display third prompt information in response to a delete operation for the target work item in the details page of the target work item, wherein the third prompt information is used to prompt that deleting a work item bound to a child process node in the second schedule is not supported in the details page; and display fourth prompt information in response to a terminate operation for the target work item in the details page of the target work item, wherein the fourth prompt information is used to prompt that terminating a work item bound to a child process node in the second schedule is not supported in the details page.

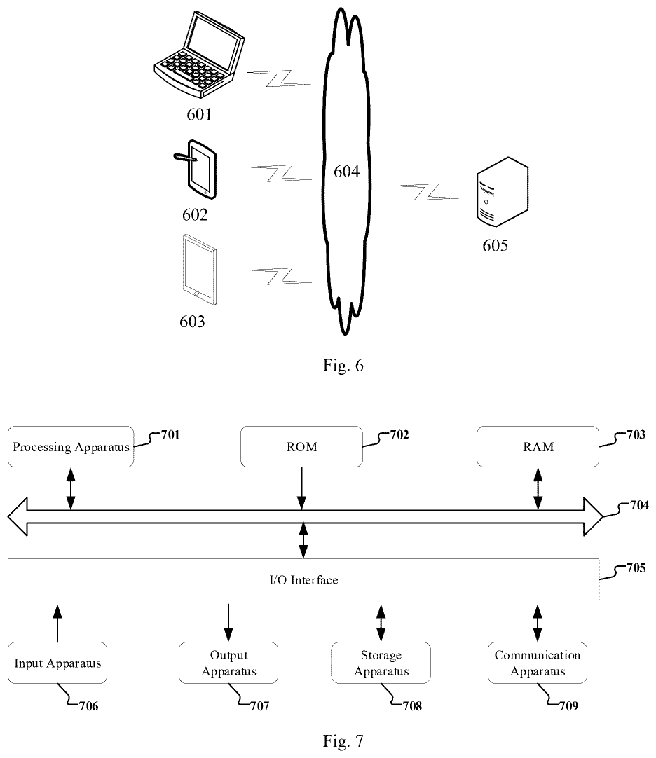

Reference is made to FIG. 6, which shows an example system architecture in which the method for processing role information in the project management system according to an embodiment of the present disclosure can be applied.

As shown in FIG. 6, the system architecture may include terminal devices 601, 602, and 603, a network 604, and a server 605. The network 604 is configured to provide a medium for a communication link between the terminal devices 601, 602, and 603 and the server 605. The network 604 may include various connection types, for example, a wired or wireless communication link, or an optical fiber cable.

The terminal devices 601, 602, and 603 may interact with the server 605 through the network 604 to receive or send messages. Various client applications may be installed on the terminal devices 601, 602, and 603, for example, a web browser application, a search application, or a news information application. The client applications in the terminal devices 601, 602, and 603 may receive a user instruction and complete a corresponding function based on the user instruction, for example, add corresponding information to information based on the user instruction.

The terminal devices 601, 602, and 603 may be hardware or software. When the terminal devices 601, 602, and 603 are hardware, they may be various electronic devices having a display screen and supporting web browsing, including but not limited to a smart phone, a tablet computer, an e-book reader, an MP3 (Moving Picture Experts Group Audio Layer III) player, an MP4 (Moving Picture Experts Group Audio Layer IV) player, a laptop portable computer, and a desktop computer, etc. When the terminal devices 601, 602, and 603 are software, they may be installed in the foregoing electronic devices. The terminal devices 601, 602, and 603 may be implemented as a plurality of software or software modules (for example, software or software modules for providing distributed services), or may be implemented as a single software or software module. This is not specifically limited.

The server 605 may be a server that provides various services, for example, receives an information acquisition request sent by the terminal devices 601, 602, and 603, and acquires display information corresponding to the information acquisition request in various manners based on the information acquisition request. The server 605 sends related data of the display information to the terminal devices 601, 602, and 603.

It should be noted that the method for processing role information in the project management system provided in this embodiment of the present disclosure may be performed by a terminal device. Correspondingly, the apparatus for processing role information in the project management system may be disposed in the terminal devices 601, 602, and 603. In addition, the method for processing role information in the project management system provided in this embodiment of the present disclosure may also be performed by the server 605. Correspondingly, the apparatus for processing role information in the project management system may be disposed in the server 605.

It should be understood that the numbers of the terminal devices, the network, and the server in FIG. 6 are merely illustrative. According to a requirement of implementation, there may be any number of terminal devices, networks, and servers.

Reference is made to FIG. 7 below, which shows a schematic structural diagram of an electronic device (for example, a terminal device or a server in FIG. 6) suitable for implementing the embodiments of the present disclosure. A terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 7 is merely an example, and shall not impose any limitation on the function and scope of use of the embodiments of the present disclosure.

As shown in FIG. 7, the electronic device may include a processing apparatus (for example, a central processor or a graphics processor) 701 that may perform a variety of appropriate actions and processing in accordance with a program stored in a read-only memory (ROM) 702 or a program loaded from a storage apparatus 708 into a random access memory (RAM) 703. The RAM 703 further stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatuses may be connected to the I/O interface 705: an input apparatus 706 including, for example, a touchscreen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a tape and a hard disk; and a communication apparatus 709. The communication apparatus 709 may allow the electronic device to perform wireless or wired communication with other devices to exchange data. Although FIG. 7 shows the electronic device having various apparatuses, it should be understood that it is not required to implement or have all of the shown apparatuses. It may be an alternative to implement or have more or fewer apparatuses.

In particular, according to embodiments of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 709, or installed from the storage apparatus 708, or installed from the ROM 702. When the computer program is executed by the processing apparatus 701, the above-mentioned functions defined in the method of the embodiment of the present disclosure are performed.

It should be noted that the foregoing computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, where the computer-readable program code is carried. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server may communicate using any currently known or future-developed network protocol such as a HyperText Transfer Protocol (HTTP), and may be connected to digital data communication (for example, a communication network) in any mode or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The foregoing computer-readable medium may be contained in the foregoing electronic device. Alternatively, the computer-readable medium may exist independently, without being assembled into the electronic device.

The foregoing computer-readable medium carries one or more programs that, when executed by the electronic device, cause the electronic device to: display a first process node of a first project in a project management interface of a project management system; and determine, from role persons of a parent node of the first process node, a role person of the first process node, and display the role person of the first process node.

The computer program code for performing the operations in the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to the computer of the user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the embodiments described in the present disclosure may be implemented by means of software, or may be implemented by means of hardware. The name of a unit does not constitute a limitation on the unit in some cases, for example, a first display unit may also be described as “a unit for displaying a first process node”.

The functions described above herein may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of a machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The foregoing descriptions are merely preferred embodiments of the present disclosure and explanations of applied technical principles. Persons skilled in the art should understand that the scope of disclosure involved in the present disclosure is not limited to the technical solutions formed by specific combinations of the foregoing technical features, and shall also cover other technical solutions formed by any combination of the foregoing technical features or their equivalent features without departing from the foregoing concept of disclosure. For example, a technical solution formed by replacing the foregoing features with technical features with similar functions disclosed in the present disclosure (but not limited thereto).

In addition, although various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments may also be implemented in combination in a single embodiment. In contrast, various features described in the context of a single embodiment may also be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A method for processing role information in a project management system, comprising:
determining, in the project management system, a role person of a first process node from role persons bound to a parent node of the first process node, based on a role person synchronization rule of the first process node in a first project, wherein the role person synchronization rule is used to indicate a rule that the first process node inherits the role person from the parent node of the first process node; and
displaying the role person of the first process node in a project management interface of the project management system.

2. The method according to claim 1, further comprising:
displaying a first schedule configuration interface of the first project, wherein the first schedule configuration interface is used to display a work breakdown structure of the first project; and
configuring the role person synchronization rule of the first process node based on a configuration operation for the first process node displayed in the first schedule configuration interface.

3. The method according to claim 2, wherein the role person synchronization rule comprises a synchronization condition, wherein the synchronization condition is used to indicate a condition satisfied by the first process node when the first process node inherits the role person.

4. The method according to claim 3, wherein the synchronization condition comprises: stopping synchronization when the first process node is completed.

5. The method according to claim 2, wherein the synchronization rule comprises a first role in the first process node and a role in the parent node that corresponds to the first role; and
determining the role person of the first process node from the role persons of the parent node of the first process node, and displaying the role person of the first process node comprise:
determining the role person in the first role in the first process node based on the role person in the role in the parent node that corresponds to the first role.

6. The method according to claim 1, wherein displaying the role person of the first process node in the project management interface of the project management system comprises:
initializing the role person in the first process node in response to creating the role person synchronization rule, and displaying the initialized role person in the first process node;
modifying the role person in the first process node in response to the role person in the parent node being modified, and displaying the modified role person in the first process node; and
displaying the role person of the first process node in response to a role of the first process node satisfying a preset visibility condition.

7. The method according to claim 1, wherein the parent node is a superior node in a node link where the first process node is located.

8. The method according to claim 1, further comprising:
deleting, for a second process node in a second project in the project management system, a work item bound to the second process node and a work item bound to a child process node of the second process node in response to deleting the second process node;
terminating, for the second process node in the second project in the project management system, the work item bound to the second process node and the work item bound to the child process node of the second process node in response to terminating the second process node; and
restoring the work item bound to the second process node and the work item bound to the child process node of the second process node in response to restoring the deleted second process node or the terminated second process node.

9. The method according to claim 8, wherein deleting, for the second process node in the second project in the project management system, a work item bound to the second process node and a work item bound to a child process node of the second process node in response to deleting the second process node comprises:
displaying a second schedule of the second project in the project management interface of the project management system, wherein the second schedule is used to display a work breakdown structure of the second project;
deleting the work item bound to the second process node and the work item bound to the child process node of the second process node in response to detecting a delete operation for the second process node in the second schedule; and
terminating the work item bound to the second process node and the work item bound to the child process node of the second process node in response to detecting a terminate operation for the second process node in the second schedule.

10. The method according to claim 8, wherein terminating, for the second process node in the second project in the project management system, the work item bound to the second process node and the work item bound to the child process node of the second process node in response to terminating the second process node comprises:
terminating the work item bound to the second process node and the work item bound to the child process node of the second process node in response to detecting a terminate operation for the second process node in a second schedule.

11. The method according to claim 8, wherein restoring the work item bound to the second process node and the work item bound to the child process node of the second process node in response to restoring the deleted second process node or the terminated second process node comprises:
restoring the work item bound to the second process node and the work item bound to the child process node of the second process node in response to a restore operation for the second process node in a second schedule.

12. The method according to claim 11, further comprising:
displaying a restore control when the schedule comprises an unpublished deleted.

13. The method according to claim 1, further comprising:
displaying a flowchart of a second project in the project management interface of the project management system; and
displaying first reminder information and a first reason input control in response to a delete operation for a third process node in the flowchart.

14. The method according to claim 1, further comprising:
displaying a details page of a root work item corresponding to a root node of a second project; and
deleting a child work item of the root work item in response to a delete operation for the root work item of the second project.

15. The method according to claim 1, further comprising:
displaying second prompt information and a first reason input control in response to a terminate operation for a root work item of a second project.

16. The method according to claim 1, further comprising:
displaying a details page of a target work item bound to a fourth process node, wherein the fourth process node is not a project root node, and the target work item establishes a binding relationship with the fourth process node in a second schedule;
displaying third prompt information in response to a delete operation for the target work item in the details page of the target work item, wherein the third prompt information is used to prompt that deleting a work item bound to a child process node in the second schedule is not supported in the details page; and
displaying fourth prompt information in response to a terminate operation for the target work item in the details page of the target work item, wherein the fourth prompt information is used to prompt that terminating a work item bound to a child process node in the second schedule is not supported in the details page.

17. An apparatus for processing role information in a project management system, comprising:
at least a processor, and
a non-transitory memory with instructions thereon,
wherein the instructions upon execution by the processor, cause the processor to:
determine, in the project management system, a role person of a first process node from role persons bound to a parent node of the first process node, based on a role person synchronization rule of the first process node in a first project, wherein the role person synchronization rule is used to indicate a rule that the first process node inherits the role person from the parent node of the first process node; and
display the role person of the first process node in a project management interface of the project management system.

18. The apparatus according to claim 17, wherein the processor is further caused to:
displaying a first schedule configuration interface of the first project, wherein the first schedule configuration interface is used to display a work breakdown structure of the first project; and
configuring the role person synchronization rule of the first process node based on a configuration operation for the first process node displayed in the first schedule configuration interface.

19. The apparatus according to claim 17, wherein the processor is further caused to:
initializing the role person in the first process node in response to creating the role person synchronization rule, and displaying the initialized role person in the first process node;
modifying the role person in the first process node in response to the role person in the parent node being modified, and displaying the modified role person in the first process node; and
displaying the role person of the first process node in response to a role of the first process node satisfying a preset visibility condition.

20. A non-transitory computer-readable storage medium storing instructions that cause at least a processor to:
determine, in a project management system, a role person of a first process node from role persons bound to a parent node of the first process node, based on a role person synchronization rule of the first process node in a first project, wherein the role person synchronization rule is used to indicate a rule that the first process node inherits the role person from the parent node of the first process node; and
display the role person of the first process node in a project management interface of the project management system.
